(19) United States
(12) Patent Application Publication
(10) Pub. No.: US 2005/0262428 A1
(43) Pub. Date: Nov. 24, 2005

(54) System and method for contextual correlation of web document content

(76) Inventors: Chad M. Little, Phoenix, AZ (US); Michael Ainsa, Phoenix, AZ (US); Bhaskar Ballapragada, Tempe, AZ (US)

Correspondence Address: Noblitt & Gilmore, LLC, Suite 6000, 4800 North Scottsdale Road, Scottsdale, AZ, 85251, US

(21) Appl. No.: 10/850,858

(22) Filed: May 21, 2004

(51) Int. Cl. G06F 17/00

(52) U.S. Cl. 715/501.1; 715/513

(57) ABSTRACT

An exemplary system and method for contextually correlating web page document text is disclosed as comprising inter alia: a context engine for analyzing at least a portion of web page document content in order to identify textual components therein as correlation candidates; and a correlation engine for marking-up or otherwise identifying textual components in association with related keywords and/or link destinations. Disclosed features and specifications may be variously controlled, adapted or otherwise optionally modified to improve correlation and/or embedded markup of web page document content for any application or operating environment. Exemplary embodiments of the present invention generally provide enhanced online searching and advertising capabilities.

### FIELD OF INVENTION

The present invention generally concerns systems and methods for computer-based searching and online advertising; and more particularly, in various representative and exemplary embodiments, to contextual correlation of web page document text with web links and/or embedded dynamic content.

### BACKGROUND

Conventional methods of advertising to large audiences via mass media outlets have employed print ads, radio spots and television commercials. Mass media advertising generally seeks to reach the most number of viewers to increase the probability of communicating with potential consumers most likely to purchase the advertised product or service. Although a large viewing audience may see the ad, advertisers understand and appreciate that only a small percentage of the audience has any real interest in purchasing the advertised product or service.

Advertisers can increase the likelihood of connecting with purchasing consumers by creating ads that appeal to potential customers and publishing the ads in media those customers are most likely to view. However, even these efforts may exclude potential consumers that do not use that particular medium and will include viewers of the medium who may have no desire to purchase the product or service. Because of this under-inclusion and over-inclusion, advertisers typically waste at least a portion of their total available budgets on consumers who are not in the market to purchase their products or services.

To mitigate unnecessary spending, advertisers often attempt to optimize their advertising efforts with respect to targeting of the viewing audience. One targeting method involves publication of ads in media outlets that are predicted to attract demographic groups likely to purchase the advertised product or service. For example, television shows often appeal to a particular type of audience as a function of age, income, education or other factors. The specific sponsors of the program sell products that appeal to the particular target audience. Similarly, in print media, advertisers may select magazines and newspapers with content, style and geographic coverage likely to attract readers that are interested in the advertised products or services.

In another targeting method, advertisers use mass media outlets to deliver ads as a part of their own media content. This method embeds advertisements in media content such that the viewer must view the ad in order to view the media content. For example, some radio and television programs incorporate advertising plugs in the program commentary or dialog. Another targeting technique involves the display of advertisements in conjunction with specific content; such as with corporate sponsored scoreboards or with logos incorporated into uniforms and equipment that are repeatedly displayed during a sporting event broadcast, for example.

Although the targeting techniques described above generally focus on a smaller, and thus more targeted, consumer audience, the over-inclusion and under-inclusion inherent in mass media advertising remain substantial drawbacks. In each marketing strategy, advertisers waste money by reaching people who are not interested in the product or service, or by excluding potential customers who may be interested. Accordingly, since these techniques assess consumer interest on the larger scale of program audiences instead of on an individual viewer basis, these techniques frequently result in squandered advertising dollars.

Recognizing many of the drawbacks typically associated with mass media ads, advertisers have turned to the Internet to increase their return on advertising investment. On the Internet, a user controls the content viewed by navigating the World Wide Web and accessing web pages. Conventional Internet-based advertising systems, however, are not suitably configured to analyze the textual content of web pages as they are viewed by users in order to more accurately qualify them as potential sales leads. Moreover, conventional sales systems generally focus on how advertisements can be more effectively and frequently displayed to potential customers at the expense of, or even despite, the viewer's established interest in the content of a particular web page.

Accordingly, what is needed is a system and method for performing contextual analysis of the document content of a web page in order to better characterize the established interest that the user has for viewing the web page content so that related links and/or advertisements may be presented to the user which are relevant to the user's interest.

### SUMMARY OF THE INVENTION

In various representative aspects, the present invention provides a system and method for contextual correlation of web page text with suggested keywords, links and/or other embedded or dynamic content. Exemplary features are generally disclosed as including: a context engine for analyzing web page text to identify words, phrases, etc. as potential correlation candidates; and a correlation engine for marking-up or otherwise indicating that the selected text components are associated with, for example, suggested keywords and/or link destinations.

Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent to skilled artisans in light of certain exemplary embodiments recited in the Detailed Description, wherein:

FIG. 1 representatively illustrates a block diagram in accordance with an exemplary system embodiment of the present invention; and

FIG. 2 representatively illustrates a process diagram in accordance with an exemplary method embodiment of the present invention.

Those skilled in the art will appreciate that elements in the Figures are illustrated for simplicity and clarity and have not necessarily been drawn to scale. For example, the dimensions of some of the elements in the Figures may be exaggerated relative to other elements to help improve understanding of various embodiments of the invention. Furthermore, the terms ‘first’, ‘second’, and the like herein, if any, are generally used for distinguishing between similar elements and not necessarily for describing a sequential or chronological order. Moreover, the terms ‘front’, ‘back’, ‘top’, ‘bottom’, ‘over’, ‘under’, and the like, if any, are generally employed for descriptive purposes and not necessarily for comprehensively describing exclusive relative position or order. Skilled artisans will therefore understand that any of the preceding terms so used may be interchanged under appropriate circumstances such that various embodiments of the invention described herein, for example, are capable of operation in other orientations and environments than those explicitly illustrated or otherwise described.

### DETAILED DESCRIPTION OF EXEMPLARY EMBODIMENTS

The following descriptions are of exemplary embodiments of the invention and the inventors' conception of the best mode and are not intended to limit the scope, applicability or configuration of the invention in any way. Rather, the following Description is intended to provide convenient illustrations for implementing various embodiments of the invention. As will become apparent, changes may be made in the function and/or arrangement of any of the elements described in the disclosed exemplary embodiments without departing from the spirit and scope of the invention.

A detailed description of an exemplary application, namely a system and method for contextual correlation of words on a web page with related keyword suggestions and/or associated links, is provided as a specific enabling disclosure that may be readily generalized by skilled artisans to any application of the disclosed system and method for contextual analysis and correlation of document text with keywords, links and/or other embedded or dynamic content.

The term “markup” and “document” may be understood to mean any electronic representation of information that may be at least partially rendered by a suitably adapted application for markup language interpretation, as well as any electronic and/or printed material(s) at least partially derived therefrom.

Much of the information available on the World Wide Web is organized into web pages that may be retrieved and displayed by web browser software under the direction of a user. Each web page is generally addressable by a respective Uniform Resource Locator (URL) text string, such as ‘http://www.mygeek.com/index.html’, that browsing software generally interprets to access the page content for subsequent rendered display. Each URL includes a domain name, such as ‘www.mygeek.com’, that identifies the website where the corresponding page is stored. Web pages are generally authored in Hypertext markup language (HTML), which is based on the SGML specification that has been adopted for defining the layout and attributes of web page documents, as well as for creating links between and within such documents.

Various representative embodiments of the present invention generally provide means for embedding intelligent contextual searching and advertising into any web page hosted, for example, on a third-party server. Third-party publishers wishing to utilize the service can place a script block or code marker on their web pages to allow the service to detect, analyze and modify the display of the page. Upon detection of the addition of a new page or changes to an existing page's content, the present invention may be configured to study its textual content and determine words or phrases contained therein that are relevant to product and service offerings or that constitute a concept that may benefit from a refined contextual search. Exemplary embodiments of the present invention may be configured to decorate selected words or phrases in such a manner as to communicate to an individual browsing the page that there is a link or action associated with them. If the individual triggers the action by, for example, moving the mouse pointer near the marked-up word or phrase (i.e., an ‘OnMouseOver’ event script), a widget (pop-up window, pop-under window, dialog box, etc.) may be displayed near the word or phrase showing related keywords, searches and/or advertising information. The widget may then be removed if the individual moves the mouse pointer away from the word or phrase. Pages marked for inclusion in the service may be analyzed once upon initial inclusion and again if any changes are made to the content of the page. Additionally, pages may be periodically analyzed regardless of their status.

The technology used for extracting candidate words or phrases may be based on a process utilizing “advisors” and a decision making “arbiter”. Advisors are generally single-purpose modules that can be added to or removed from various embodiments of the present invention at any time, allowing the intelligence of the system to be continually refined and expanded. The output of an advisor is generally feed to an arbiter which selects the final target words or phrases for subsequent markup and display. Exemplary factors that advisors may use to suggest candidates for the arbiter's consideration include: word frequency counts, word ranking based on popularity and search engine queries, pricing of words from advertising networks, clustering of words by conceptual relationship, examination of words from other pages that link into or out of the page in consideration, or words obtained from related keyword or searches. The arbiter may be configured to generally incorporate knowledge from any adviser with the use of weighted average functions and/or historical feedback to determine the final list of candidate targets. Output from the target selection may be saved for future use.

Display of an action widget is geared towards web-based presentation platforms such as DHTML and Flash; however, the service may be configured in such a way that new presentation layers may be easily added with any tools now known or hereafter described in the art. The action widget may be suitably adapted to adjust its display to show search content and advertising information including: words representing concepts related to candidate target words; words sharing the target word as a root; words of brands or products and services similar to the target candidate; etc. The action widget may expand itself in a tree-like manner, allowing the individual using it to drill down words they find interesting. Associated keywords may periodically be rotated in order to evaluate and optimize user click-through-rates.

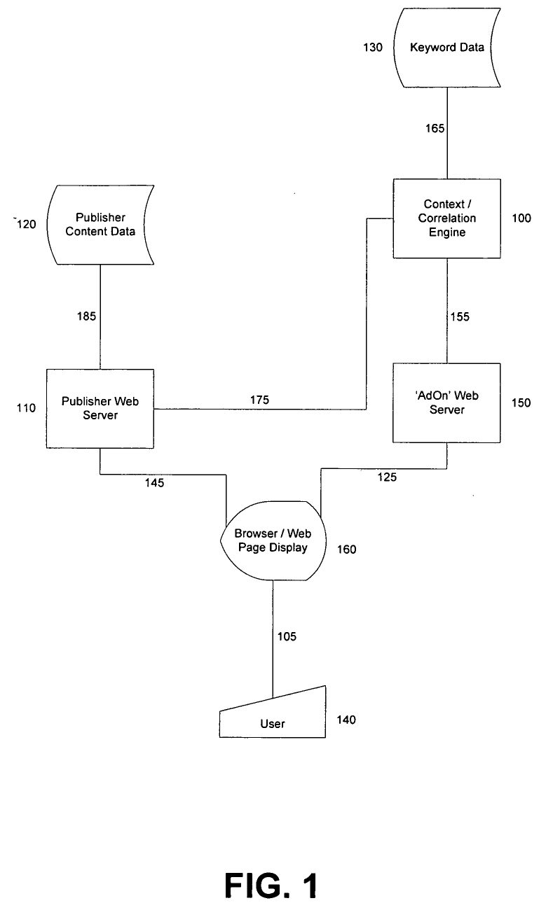

As generally depicted in FIG. 1 for example, user 140 may interact with a publisher web server 110 over data connection 145 by operation of a web browser 160 application. Upon receipt of a web service request from user 140, publisher web server 110 accesses web document content 120 over data connection 185. The publisher web page is rendered on the web browser 160. If the web page content contains a code marker or script block indicating that the document is to be processed for contextual correlation, the web browser 160 will issue a request to the adontext server 150 over data connection 125 for additional data. The adontext server 150 will forward the request along with the URL of the originating webpage to the context/correlation engine 100 over data connection 155 to process the document content. Context/correlation engine 100 may then issue a request to the publisher web server 110 over data connection 175 for a copy of publisher content being delivered to the user 140. The publisher web server 110 renders the same publisher content 120 to the contextual engine 100 over data connection 175 for subsequent contextual analysis and/or correlation. Context/correlation engine 100 may also be suitably configured to access data from keyword database 130 over data connection 165 for correlation of web document text with related keywords and/or associated destination links.

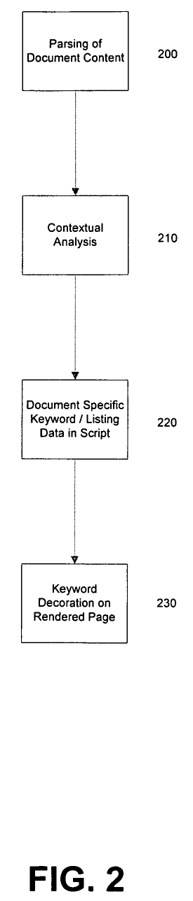

As representatively depicted in FIG. 2 for example, context engine 100 may begin processing web page content 120 by optionally parsing 200 the document to eliminate textual components from submission as potential candidates for subsequent contextual analysis based on, for example predetermined word frequency (e.g., in order to reduce the number of common terms such as: ‘the’, ‘a’, ‘of’, ‘in’, etc.), contextual ambiguity (e.g., as with the term ‘virus’in its application to: medical diseases—or—malicious computer code), etc. Skilled artisans will appreciate that various other metrics, criteria and/or algorithms may be employed for parsing or otherwise preconditioning web page document content prior to engagement of contextual analysis.

Optionally parsed document content may then be provided to context engine 100 for analysis. Contextual analysis 210 of the document content may proceed based on any or all of the following: a lookup table, word frequency, word density, in-bound links, out-bound links, historical user link destinations, a browser cookie, browser cache data, URL history data, a word relevance value, previously rendered document content (web pages, graphic images, video clips, etc.), a word weighting metric, a phrase weighting metric, keyword ad pricing, word clustering algorithms, a weighted average function, historical feedback data and/or any other analysis metric whether now known to skilled artisans, hereafter derived or subsequently described in the art.

The results of contextual analysis 210 may then be provided to correlation engine 100 for association with keywords and/or related links (see 130). Correlation engine 100 provides data to adontext server 150 which generates a web page specific data script 220 which is delivered to browser 160 over data connection 125. The webpage script may also be configured to markup web page rendered on the browser 160 to provide an identifying element within the content of web document so as to indicate that a particular correlated text component is associated with at least one keyword and/or related destination link. The identifying element may comprise, for example, an underline, a double underline, a strike-through, a superscript, a subscript, italicized font, bold font, capitalization, case change, color, shape, a pop-up window, a DHTML layer, status bar text, sound, animation, a video clip, an image, a variant cursor, an icon and/or any identification mechanism whether now known to skilled artisans, hereafter derived or subsequently described in the art. The marked-up correlated web content (see 220) is rendered to the user 140 for viewing along with suggestions for related keywords and/or associated link destinations.

In other exemplary embodiments in accordance with the present invention, any or all of publisher web server 110, publisher content 120, third party web server 150, context/correlation engine 100, and/or keyword database 130 may be housed on a single computer system or a plurality of computer systems. Typically, the publisher web server 110 and publisher content 120 are under the control of publisher whereas the adontext server 150, the contextual engine 100 and/or keyword database 130 are under the control of the adontext provider. In still other exemplary and representative embodiments, context/correlation engine 100 may be divided into separate system components, such as, for example, a substantially unitary context engine and a substantially unitary and distinct correlation engine.

In various exemplary embodiments, any of data connections 105, 125, 145, 155, 165, 175, 185 may comprise a local area network connection, a wide area network connection, a client/server data connection over the local loop, the Internet and/or any data communication path currently known or subsequently described in the art.

JavaScript code modules may be provided to publishers for addition to their web document content in order to make pages ‘hot’. Addition of the JavaScript module may also be adapted to trigger any or all of the following events: spidering of the pages for content; breaking down the text content to limit common terms typically called “stopwords” such as ‘and’, ‘the’, etc.; selection of keywords to be highlighted or otherwise identified; computing the number of keywords to be highlighted or otherwise identified as a function of the volume of content on the page; providing a minimum number of keywords per page; providing a maximum number of keywords per page; providing a minimum number of keywords per paragraph; providing at least one keyword for a certain number of distinct words; providing a pop-up list (e.g., a DHTML layer) of related searches as determined by the selection of a single keyword; providing a weighting function for ranking keywords based on their occurrence or frequency on a particular page; providing a weighting function for ranking keywords based on the volume of searches using those terms; weighting on occurrences on other pages in the publishers website; weighting on pages with in-bound links; weighting on pages with out-bound links; weighting on price; weighting on the number of results returned; performing relevance matching on keywords and other content within the page; rotating through keywords to determine which ones provide the best click-through-rates; rotating through top-related keywords; determining related keywords; providing script code for ‘OnMouseOver’ events and/or the like where related keywords may be configured to display a title and description of the top listings; etc.

An exemplary aspect of the present invention allows publishers to translate their web content into cost-per-click search content in order to generate incremental revenue with utilization of, for example, easy to implement JavaScript code modules. The system may be configured with a publisher management interface and/or keyword management interface to allow publishers and/or advertisers to access and modify criteria for the optimization of keyword and/or destination link correlation.

The present invention increases the relevancy of targeted searches and targeted advertising efforts. Related searches offer more targeted searching capabilities. Conventional methods generally provide one result per keyword, thereby reducing relevancy and quality of the consumer experience. The present invention is more specific. Conventional methods generally operate to define a domain via a limited set of keywords, which greatly reduces the relevancy and available keyword inventory. The present invention may be adapted to routinely spider the publisher's web document content on a page-by-page basis, thereby reducing the need to categorize a website. Pages may then be more effectively analyzed for unique content and targeted demographic intent.

In an exemplary embodiment, the present invention may be deployed in the context of a publisher where the number of web documents may be quite large and/or constantly changing. Also, the number of users viewing the documents may be large. In that case, any of data connections 105, 125, 145, 155, 165, 175, 185 may generally correspond to the Internet. As used herein, the term ‘Internet’ generally refers to a substantially global, packet-switched network utilizing the TCP/IP suite of protocols or any other suitable protocols. Notwithstanding the preceding, the present invention may be implemented in various other network contexts as well, including any future alternatives to the Internet, in addition to other suitable inter-networks or intra-networks based on either open or proprietary protocols. For further information concerning data network communication protocols, standards and applications utilized in connection with the Internet, see, for example: Dilip Naik, ‘Internet Standards and Protocols’ (1998); ‘Java 2 Complete’, various authors, (Sybex 1999); Deborah Ray And Eric Ray, ‘Mastering Html 4.0’ (1997); and Loshin, ‘TCP/IP Clearly Explained’ (1997).

Databases 120 and/or 130 may be any type of database, such as relational, hierarchical, object-oriented, and/or the like. Representative database products that may be used to implement databases 120, 130 include DB2 by IBM (White Plains, N.Y.), any of the database products available from ORACLE CORPORATION (Redwood Shores, Calif.), MICROSOFT ACCESS by MICROSOFT CORPORATION (Redmond, Wash.), Sybase (Dublin, Calif.) or any other database product. The databases may be organized in any manner, including, for example, data tables, look-up tables, matchable data structures or any other method and/or data structure now known or hereafter derived or otherwise described by those skilled in the art.

Association of certain data may be accomplished through any data association technique known and practiced in the art. For example, the association may be accomplished either manually or automatically. Automatic association techniques may include, for example, a database search, a database merge, GREP, AGREP, SQL, and/or the like. Data association may be accomplished by a database merge function, for example, using a key field to generally partition the database according to a class of objects defined by the key field. For example, a certain class may be designated as a key field in both a first data table and a second data table, and the two data tables may then be merged on the basis of the class data in a key field. In an exemplary embodiment, the data corresponding to a key field in each of the merged data tables may be the same; however, data tables having similar, though not identical, data in key fields may also be merged by using AGREP, for example.

Publisher Web server 110 generally comprises any combination of hardware, software, and/or networking components configured to receive and process requests from client computer(s) 140 and provides a suitable website or other Internet-based user interface which is accessible by client(s) 140. In an exemplary embodiment, the Internet Information Server, MICROSOFT Transaction Server, and MICROSOFT SQL Server, may be used in conjunction with the MICROSOFT operating system, MICROSOFT NT web server software, a MICROSOFT SQL database system, and a MICROSOFT Commerce Server. Additionally, components such as Access, SQL Server, Oracle, MySQL, Sybase, InterBase, and/or the like may be used to provide a compliant database-driven web content management system.

The term ‘web page’or ‘web content’, as used herein, is not meant to limit the type of documents and applications that might be used to interact with client users 140. For example, a typical website may include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, etc. or any other web-based content, whether now known, hereafter derived or otherwise described in the art.

Various representative embodiments of the present invention may be adapted to work with any number of web servers in any permutation of connectivity, such as that of a fail-over or bandwidth acceleration configuration. Skilled artisans will appreciate that numerous optional variants known in the art may be employed for the provision of web access to clients 140.

Data connections 105, 145, 155, 165, 175, 185, 195 may comprise a ny combination of hardware, software and/or other networking components configured to provide communication data paths. A variety of conventional communications media and protocols may be used for data paths 105, 125, 145, 155, 165, 175, 185 such as, for example, an Internet Service Provider (ISP) over the local loop, as is typically used in connection with standard modem communication, a cable modem, a Dish network, an ISDN connection, a Digital Subscriber Line (DSL), various wireless communication methods (e.g., 802.11b/g, BlueTooth, etc.) and/or the like. Device components connected via data paths 105, 125, 145,155, 165, 175, 185 may also reside within a local area network (LAN) which interfaces to an external network, such as the Internet, via a leased line (T1, T3, etc.). Notwithstanding the preceding, skilled artisans will appreciate that the present invention may be implemented in other network environments as well, including any future alternatives to the Internet, in addition to other suitable inter-networks and/or intra-networks based on other open or proprietary protocols.

Skilled artisans will appreciate that the data connection configurations depicted in the figures are provide for representative and convenient illustration and that many other data connection configurations may be alternatively, conjunctively and/or sequentially employed to produce substantially the same result. The present invention may be described herein in terms of functional block components and various processing steps. It should be appreciated that such functional blocks may be realized by any number of hardware and/or software components configured to perform the specified functions. For example, the present invention may employ various integrated circuit components, e.g., memory elements, processing elements, logic elements, data structures, and/or the like, which may carry out a variety of functions under the control of one or more microprocessors or other control devices. Similarly, the software elements of the present invention may be implemented with any programming or scripting language such as, for example, C, C++, Java, COBOL, assembler, PERL, extensible Markup Language (XML), etc., and/or any programming or scripting language now known or hereafter derived or otherwise described in the art, with the various algorithms being implemented with any combination of data structures, objects, processes, routines or other programming elements. Furthermore, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction to cryptography and digital security, please see the text by Bruce Schneider entitled “Applied Cryptography: Protocols, Algorithms, and Source Code In C,” published by John Wiley & Sons (second edition, 1996).

It should be appreciated that the particular implementations shown and described herein are representative of the invention and its best mode and are not intended to limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between various elements. It should be noted that many alternative or additional functional relationships or physical connections may be present in a practical system.

It will be appreciated, that many applications of the present invention may be formulated. One skilled in the art will appreciate that the network may include any system for exchanging data, such as, for example, the Internet, an intranet, an extranet, WAN, LAN, wireless network, satellite communications, and/or the like. It is noted that the network may be implemented as other types of networks, such as an interactive television (ITV) network. The users may interact with the system via any input device such as a keyboard, mouse, kiosk, personal digital assistant, handheld computer (e.g., PALM PILOT, POCKET PC), cellular phone and/or the like. Similarly, the invention could be used in conjunction with any type of personal computer, network computer, workstation, minicomputer, mainframe, and/or the like running any operating system such as any version of Windows, Windows XP, Windows Whistler, Windows ME, Windows NT, Windows2000, Windows 98, Windows 95, MacOS, OS/2, BeOS, Linux, UNIX, or any operating system now known or hereafter derived by those skilled in the art. Additionally, the invention may be readily implemented with TCP/IP communications protocols, IPX, Appletalk, IP-6, NetBIOS, OSI or any number of existing or future standards or protocols. Moreover, the system contemplates the use, sale and/or distribution of any goods, services or information having similar functionality described herein.

The computing units may be connected with each other via a data communication network. The network may be a public network and assumed to be insecure and open to eavesdroppers. In one exemplary implementation, the network may be embodied as the Internet. In this context, the computers may or may not be connected to the Internet at all times.

As will be appreciated by skilled artisans, the present invention may be embodied as a method, a system, a device, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code embodied in the storage medium. Any suitable computer-readable storage medium may be utilized, including hard disks, CD-ROM, optical storage devices, magnetic storage devices, and/or the like.

Data communication may be accomplished through any suitable communication means, such as, for example, a telephone network, Intranet, Internet, point of interaction device (POS device, personal digital assistant, cellular phone, kiosk, etc.), online communications, off-line communications, wireless communications, and/or the like. One skilled in the art will also appreciate that, for security reasons, any databases, systems, or components of the present invention may consist of any combination of databases or components at a single location or at multiple locations, wherein each database or system component optionally includes any of various suitable security features, such as firewalls, access codes, encryption, de-encryption, compression, decompression, and/or the like.

The present invention is described herein with reference to block diagrams, devices, aggregated systems and computer program products according to various aspects of the invention. It will be understood that each functional block of the block diagrams, and combinations of functional blocks in the block diagrams, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the block diagrams.

These computer program instructions may also be stored in a computer-readable memory that can direct a computer or other programmable data processing device to function in a particular manner, such that the instructions stored in the computer-readable memory produce an article of manufacture including instruction means which implement the functions specified in the block diagrams. The computer program instructions may also be loaded onto a computer or other programmable data processing device to cause a series of operational steps to be performed on the computer or other programmable apparatus to produce a computer-implemented process such that the instructions which execute on the computer or other programmable apparatus provide steps for implementing the functions specified in the block diagrams.

Accordingly, the block diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams, can be implemented by either special purpose hardware-based computer systems which perform the specified functions or steps, or suitable combinations of special purpose hardware and computer instructions.

In the foregoing specification, the invention has been described with reference to specific exemplary embodiments; however, it will be appreciated that various modifications and changes may be made without departing from the scope of the present invention as set forth in the claims below. The specification and Figures are to be regarded in an illustrative manner, rather than a restrictive one and all such modifications are intended to be included within the scope of the present invention. Accordingly, the scope of the invention should be determined by the Claims appended hereto and their legal equivalents rather than by merely the examples described above. For example, the steps recited in any method or process claims may be executed in any order and are not limited to the specific order presented in the Claims. Additionally, the components and/or elements recited in any system claims may be assembled or otherwise operationally configured in a variety of permutations to produce substantially the same result as the present invention and are accordingly not limited to the specific configuration recited in the Claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the Claims.

As used herein, the terms ‘comprises’, ‘comprising’, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

1. A system for correlating web page text with at least one of a link destination and dynamic document content, said system comprising:
a context engine suitably adapted to perform contextual analysis of at least a portion of said web page text in order to identify at least one textual component as a candidate for correlation; and
a correlation engine suitably adapted to mark-up said textual component to indicate that said textual component is correlated to at least one of said link destination and said dynamic document content.

2. The system of claim 1, wherein said dynamic document content comprises at least one of a keyword suggestion and an associated link.

3. The system of claim 1, wherein said dynamic document content comprises at least one of a plurality of keyword suggestions and a plurality of associated links.

4. The system of claim 1, wherein said context engine and said correlation engine are embodied in at least one of a substantially unitary hardware product and a substantially unitary software product.

5. The system of claim 1, wherein said markup of said textual component comprises at least one of a graphic decoration of said textual component and an ‘OnMouseOver’ event.

6. The system of claim 1, further comprising:
at least one database;
said database having at least one of keyword data and web page document data stored therein; and
said database hosted from at least one of a local server, a local network server and a remote server.

7. The system of claim 1, further comprising at least one of a web server, a management interface and a web browser client.

8. The system of claim 7, wherein said management interface comprises at least one of a context engine management interface and a correlation engine management interface.

9. The system of claim 1, wherein said context engine is suitably adapted to perform contextual analysis at least partially based on at least one of a lookup table, word frequency, word density, in-bound IP address, in-bound links, out-bound links, historical user link destinations, browser cache data, URL history data, word relevance values, previously rendered document content, a word weighting metric, a phrase weighting metric, keyword ad pricing, word clustering, a weighted average function, and historical feedback.

10. A method for contextual correlation of web page document content, said method comprising the steps of:
providing at least a portion of content from a web page document;
optionally parsing at least a portion of said document content;
performing a contextual analysis of at least a portion of said optionally parsed document content in order to identify at least one text component of said document content as a candidate for correlation;
correlating said document text component to at least one of a keyword and an associated link destination ; and
adding at least one identifying element to the document content to provide an indication that said text component is correlated to at least one of said keyword and said associated link destination.

11. The method of claim 10, wherein said correlated text component comprises at least one of a word, a clause, a phrase and a sentence.

12. The method of claim 11, further comprising the step of rendering the resulting web page document to an end-user on a web browser.

13. The method of claim 10, further comprising the step of eliminating at least one text component from submission as a candidate for contextual analysis based on at least one of word frequency and contextual ambiguity.

14. The method of claim 10, where said step of contextual analysis is at least partially based on at least one of a lookup table, word frequency, word density, in-bound IP address, in-bound links, out-bound links, historical user link destinations, browser cache data, URL history data, a word relevance value, previously rendered document content, a word weighting metric, a phrase weighting metric, keyword ad pricing, word clustering, a weighted average function, and historical feedback.

15. The method of claim 10, further comprising the step of providing at least one suggested keyword to better characterize the user's contextual interest in the document content.

16. The method of claim 15, wherein said suggested keyword is correlated to at least one of a second suggested keyword and a second associated link destination.

17. The iterative application of any of the steps of claim 15 for the optimized correlation of document content in order to provide at least one of a plurality of related keywords and a plurality of associated link destinations.

18. A system for processing web page document content, said system comprising:
a web content publisher;
said publisher providing at least a portion of web document content for correlation analysis;
said publisher optionally configured with a database for at least one of storing and serving said web document content;
a keyword management agent;
an advertiser, said advertiser providing at least one keyword to said agent, said keyword associated with at least one destination link;
said agent suitably configured to access said web document content;
said agent suitably configured for optionally parsing at least a portion of said web document content;
said agent suitably configured for performing contextual analysis of at least a portion of said optionally parsed document content in order to identify at least one text component of said document content as a candidate for correlation;
at least one of said agent and said publisher suitably configured for correlating said document text component to at least one of said keyword and said associated destination link;
at least one of said agent and said publisher suitably configured for adding at least one identifying element to the web document content to provide an indication that said document text component is correlated to at least one of said keyword and said associated destination link; and
said identifying element optionally comprising at least one of an underline, a double underline, a strike-through, a superscript, a subscript, an italicized font, a bold font, capitalization, case, color, shape, a pop-up window, a DHTML layer, status bar text, sound, animation, a video clip, an image, a variant cursor graphic, and an icon.

19. The system of claim 18, where said contextual analysis is at least partially based on at least one of a lookup table, word frequency, word density, in-bound IP address, in-bound links, out-bound links, historical user link destinations, browser cache data, URL history data, a word relevance value, previously rendered document content, a word weighting metric, a phrase weighting metric, keyword ad pricing, word clustering, a weighted average function, and historical feedback.

20. The system of claim 18, wherein said agent further comprises at least one of a context engine management interface and a correlation engine management interface.
